(19) United States
(12) Patent Application Publication
(10) Pub. No.: US 2024/0377341 A1
(43) Pub. Date: Nov. 14, 2024

(54) METHOD, DEVICE AND COMPUTER PROGRAM FOR MONITORING A PART BY X-RAY

(71) Applicants: SAFRAN, PARIS (FR); CENTRE NATIONAL DE LA RECHERCHE SCIENTIFIQUE (CNRS), PARIS (FR); ECOLE NORMALE SUPERIEURE PARIS-SACLAY, GIF SUR YVETTE (FR)

(72) Inventors: Cédric FRAGNAUD, MOISSY-CRAMAYEL (FR); Stéphane ROUX, ROSNY-SOUS-BOIS (FR); Julian BETANCUR, MOISSY-CRAMAYEL (FR)

(73) Assignees: SAFRAN, PARIS (FR); CENTRE NATIONAL DE LA RECHERCHE SCIENTIFIQUE (CNRS), PARIS (FR); ECOLE NORMALE SUPERIEURE PARIS-SACLAY, GIF SUR YVETTE (FR)

(21) Appl. No.: 18/690,681

(22) PCT Filed: Sep. 8, 2022
(86) PCT No.: PCT/FR2022/051698

§ 371 Date: Mar. 8, 2024

(30) Foreign Application Priority Data
Sep. 9, 2021 (FR) FR2109443

(51) Int. Cl. G01N 23/18; G01N 23/20066

(52) U.S. Cl. CPC G01N 23/18; G01N 23/20066

(57) ABSTRACT

The invention relates to a method for non-destructively testing a part by means of transmission radiography, which method comprises the following steps of acquiring N projections (P⁽ⁿ⁾) of the part, generating calculated N images (P⁽ⁿ⁾) of the part, estimating, by successive iterations, the vector p from an initial vector p=pᵢₙᵢ and the vector c from an initial vector c=cᵢₙᵢ and/or the parameter vector a from an initial vector α=αᵢₙᵢ, by minimising the sum of the squared differences between the projections (P⁽ⁿ⁾) and the images (P⁽ⁿ⁾), processing the projections (P⁽ⁿ⁾) and/or the images (P⁽ⁿ⁾), identifying defects in the part by comparing the processed projections (P⁽ⁿ⁾) and the processed images (P⁽ⁿ⁾).

The invention relates to a method, a device and a computer program for the non-destructive testing of a part by X-ray radiography.

The field of the invention relates to aeronautical parts, particularly turbomachine blades, particularly their turbine blades.

The Non-Destructive Testing (NDT) of aeronautical parts is an essential element of the operational safety of airplanes, the aim of which is to avoid any defect that could cause an in-flight failure. Among NDT methods, X-ray radiography is distinguished by its capacity to view the inside of the part in a largely or completely non-intrusive manner and to resolve details down to a micron in size. These performances have made it popular in the aeronautical sector. X-ray radiography makes it possible to image the internal structure of the part in transmission mode. Tomography consists in the acquisition of a large number of X-rays during a rotation, usually full, of a part with the aim of computing a full three-dimensional image of a part. The long acquisition time of these tomographic images leads industrial manufacturers to consider only a limited number of radiographic images (hereinafter referred to as X-rays or projections) to carry out NDT of the material health and dimensions (three-dimensional geometrical information). However, image artefacts due to beam hardening and Compton scattering affect X-rays and make the metrological analysis carried out during NDT difficult or uncertain. When a large number of projections is considered, for example in the context of tomography, these artefacts can be neglected. On the other hand, they must be carefully taken into account when the NDT is carried out from a small number of views.

Digital radiography NDT cabinets (of the registered trademarks such as Yxlon, GE, Nikon) or operating software (Vg Studio, Aviso, RX solution) and software for processing images obtained by X-ray radiography all have filters to help the controller in his evaluation task. A (normalized) X-ray is interpreted as an image of the attenuation of the X-rays as they pass through the part, an attenuation itself connected to the thickness by a law often approximated as an exponential function (Beer-Lambert law). The quantities of interest in the characterization of geometrical indicators are three-dimensional in nature, and their estimation based on X-rays (two-dimensional images) is partial and not very reliable. This can give rise to non-trivial errors in the test, and makes the evaluation procedure sensitive to the variation of the angle of view at the time of acquisition of each image. The analysis therefore requires a precise knowledge of the geometry of the cabin-part system, and on the faithful correction of the image artefacts. The use of X-ray tomography involves the acquisition of one or more thousands of projections, which is time-consuming and also leads to processing steps which have to be considered. Thus, it is preferable to acquire only a small number of projections (around ten), i.e. typically a hundred times less.

Part evaluation by X-ray based on a small number of views is usually done manually: testers, specialist technicians trained in this task, analyze the images produced by the system searching for any anomaly. Anomalies are represented by an abnormal variation in the gray levels of the images. However, image artefacts alter these gray levels, making evaluation uncertain and difficult: when a small number of images is considered, the image artefacts have a high weight and cannot be neglected. Thus, the reduction in imaging artefacts for the evaluation of aeronautical parts based on a limited number of projections is a crucial factor for this application. For acceleration voltages of around 350 keV (typically used to acquire turbine blade images), the artefacts to be processed are essentially beam hardening and Compton scattering.

An inter- and intra-tester variability exists, reducing the reliability of the evaluation. Moreover, the thorough analysis of the images by the controller is a laborious, tiring job, on both the physical and psychological level.

One aim of the invention is to obtain a method, a device and a computer program for the non-destructive testing of a part by X-ray radiography, which overcome the drawbacks mentioned above, by minimizing one or more types of image artefact then allowing the exploitation of a small number of acquired projections to carry out the NDT.

For this purpose, a first subject matter of the invention is a method of non-destructive testing of a part by transmission radiography, comprising the following steps, executed by a calculator:
acquiring of N projections of the part using a transmission radiography device from N different and predetermined angles of view of the part, where N is a given natural integer,
generating of N computed images of the part from a reference model of the part corresponding to the N angles of view and from a vector p of parameters characterizing a projection geometry of acquisition for the N angles of view at each of several successive iterations,
estimating, by the successive iterations, of the vector p from an initial vector p=pᵢₙᵢ and of at least one of a vector c of parameters from an initial vector c=cᵢₙᵢ and of a vector α of parameters from an initial vector α=αᵢₙᵢ, where the vector c of the parameters accounts for beam hardening of radiation in the part and the vector α of the parameters characterizes Compton scattering of the radiation in the part, by minimizing the sum of the norms of the squared differences between the N projections having been acquired and the N computed images,
processing of the N projections and/or of the N computed images comprising a first processing and/or a second processing,
   the first processing comprising a correction of the beam hardening over the N projections from the vector c having been estimated or a generation of the beam hardening over the N computed images from the vector c having been estimated,
   the second processing comprising a correction of the Compton scattering over the N projections from the vector α having been estimated or a generation of the Compton scattering over the N computed images from the vector α having been estimated,
identifying of defects of the part by comparison of the N projections having been processed with the N computed images having been processed.

The invention thus allows the non-destructive testing of aeronautical parts by X-ray radiography, based on a limited number of acquired projections. The invention allows the evaluation of aeronautical parts using a limited number of acquired projections (which can for example be less than or equal to 1000) of the inspected part. Specifically, after application of the algorithmic processing described in the invention, the images acquired by the system and those reproduced by simulation may be quantitatively compared, and a evaluation based on their differences is made. The method, the device and the control program according to the invention help with the evaluation of the inspected part. The procedure being systematically parameterized, this evaluation is then made more reliable.

The invention presents a method of NDT based on a small number of projections. The invention makes it possible to increase the reliability of the testing method and device, but also its performance by allowing the evaluation of the part with a limited number of projections. To do this, one or more types of artefact are estimated from their modelling. This estimate is used either to correct the artefacts in the acquired images, or to reproduce them in simulated images based on the model of the ideal part (for example its computer-assisted design model or CAD model). This is made possible by the reproduction of the modifications in the intensity of the pixels, described as artefacts, due to the physical phenomena which are responsible for deviations from the simple Beer-Lambert law, such as beam hardening or Compton scattering. Accounting for these phenomena allows a more meaningful comparison of the gray levels between the acquired and the simulated, and therefore a more accurate evaluation. Once these artefacts are considered, the proposed NDT method makes it possible to highlight all the indicators whatever their nature (material health, geometrical), or their position in the part, independently of the acquisition conditions used (following the NDT evaluation process defined in an industrial context), or of the part geometry. The gain in reliability is not accompanied by any cost, unless it be the modest cost of modelling the projection.

The invention particularly relates to the installation of a control system consisting of a device for acquisition of X-rays radiographies of a part composed of a single known material, coupled with an evaluation and validation algorithm. The algorithmic processing makes it possible to minimize one or more types of image artefacts expected for the material and the power of the X-ray beam used, or else to reproduce them, in such a way as to make the acquired images and simulated images quantitatively comparable.

The beam hardening may be corrected by the computer by performing a calibration of the attenuation, then a correction of the image intensities.

According to an embodiment of the invention, the method comprises at each iteration estimating of the vector p of the parameters pi of the projection geometry of the acquisition for the N angles of view by the calculator, the estimating comprising:
computing of projection residuals ρₚ⁽ⁿ⁾=P⁽ⁿ⁾−\hat{P}⁽ⁿ⁾ from the initial vector p=pᵢₙᵢ of initial values,
computing of sensitivity fields sₚ_{ᵢ}⁽ⁿ⁾ according to

$${{s}_{{p}_{i}}^{( n )} = \frac{\partial {\hat{P}}^{( n )}}{\partial {p}_{i}} \vert}_{p}$$

from the initial vector p=pᵢₙᵢ of the initial values,
where
\hat{P}⁽ⁿ⁾ are the N computed images for the N angles of view,
P⁽ⁿ⁾ are the N projections having been acquired of the part,
p is a column vector of the parameters pi of the projection geometry,
pᵢₙᵢ is a column vector of the initial values of the parameters pi of the projection geometry,
n is a natural integer denoting the number of the angle of view and ranging from 1 to N,
p is updated according to p*=p+δp*, where
p* is a column vector of the parameters pi of the projection geometry having been updated,
δp* is a column vector of variation of the parameters pi of the projection geometry and is calculated as a δp minimizing the sum of the norms of the squared differences between the projection residuals ρₚ⁽ⁿ⁾ and the product of δp by sₚ⁽ⁿ⁾ for n ranging from 1 to N,

$$δ {p}^{*} = arg {min}_{δ p} {\sum }_{( n )} {‖ {ρ}_{p}^{( n )} - {s}_{p}^{( n )} δ p ‖}^{2}$$

where δp is a column vector, sₚ⁽ⁿ⁾ is a matrix of the sensitivity fields sₚ_{ᵢ}⁽ⁿ⁾.

According to an embodiment of the invention, the method comprises at each iteration estimating of the vector c of the parameters cₖ of calibration of the beam hardening of the radiation in the part by the calculator, the estimating comprising:
computing of projection residuals ρ_{c}⁽ⁿ⁾=P⁽ⁿ⁾−P̆⁽ⁿ⁾ from the initial vector c=cᵢₙᵢ of initial values,
computing of sensitivity fields s_{c}_{ₖ}⁽ⁿ⁾ according to

$${{s}_{{c}_{k}}^{( n )} = \frac{\partial {\breve{P}}^{( n )}}{\partial {c}_{k}} \vert}_{c}$$

from the initial vector c=cᵢₙᵢ of the initial values,
where P̆⁽ⁿ⁾(x)=u(\hat{P}⁽ⁿ⁾(x)) is an image obtained by applying a function u(y) to an intensity
y of each of pixels x of \hat{P}⁽ⁿ⁾,
\hat{P}⁽ⁿ⁾ are the N computed images for the N angles of view,
P⁽ⁿ⁾ are the N projections having been acquired of the part,
c is a column vector of the parameters cₖ of calibration of the beam hardening,
cᵢₙᵢ is a column vector of the initial values of the parameters cₖ of calibration of the beam hardening of the radiation in the part,
φₖ(y) is a base of given form functions,

$$u ( y ) = {\sum }_{k = 1}^{{K}_{3}} {c}_{k} {φ}_{k} ( y )$$

K₃ is a given natural integer greater than or equal to 1,
k is a natural integer ranging from 1 to K₃,
c is updated according to c*=c+δc*, where
c* is a column vector of the parameters cₖ of calibration of the beam hardening of the radiation in the part, having been updated,
δc* is a column vector of variation of the parameters cₖ of calibration of the beam hardening of the radiation in the part and is computed as a δc minimizing the sum of the norms of the squared differences between the projection residuals ρ_{c}⁽ⁿ⁾ and the product of δc by s_{c}⁽ⁿ⁾ for n ranging from 1 to N,

$$δ {c}^{*} = arg {min}_{δ c} {\sum }_{( n )} {‖ {ρ}_{c}^{( n )} - {s}_{c}^{( n )} δ c ‖}^{2}$$

where δc is a column vector, s_{c}⁽ⁿ⁾ is a matrix of the sensitivity fields s_{c}_{ₖ}⁽ⁿ⁾.

According to an embodiment of the invention, the method comprises at each iteration estimating of the vector α of the parameters αⱼ of Compton scattering of the radiation in the part by the calculator, the estimating comprising:
computing of projection residuals ρ_{α}⁽ⁿ⁾=P⁽ⁿ⁾−\tilde{P}⁽ⁿ⁾ from the initial vector α=αᵢₙᵢ of the initial values,
computing of sensitivity fields s_{α}_{ⱼ}⁽ⁿ⁾ according to

$${{s}_{{α}_{j}}^{( n )} = \frac{\partial {\tilde{P}}^{( n )}}{\partial {α}_{j}} \vert}_{α}$$

from the initial vector α=αᵢₙᵢ of the initial values,
where P⁽ⁿ⁾ are the N projections having been acquired of the part,
\hat{P}⁽ⁿ⁾ are the N computed images for the N angles of view,
\tilde{P}⁽ⁿ⁾=P̆⁽ⁿ⁾+P̆⁽ⁿ⁾*K is an image obtained by convolution of simulated images P̆⁽ⁿ⁾, having been obtained from at least the N computed images \hat{P}⁽ⁿ⁾, with a kernel δ+K,
α is a column vector of the parameters αⱼ of Compton scattering of the radiation in the part,
αᵢₙᵢ is a column vector of the initial values of the parameters αⱼ of Compton scattering of the radiation in the part,
K is a convolution kernel defined by

$$K ( x ) = {\sum }_{j = 1}^{{K}_{2}} {α}_{j} ( {ℊ}_{{σ}_{j}} ( x ) - δ ( x ) )$$

K₂ is a prescribed natural integer greater than or equal to 1,
j is a natural integer ranging from 1 to K₂,
g_{σ}_{ⱼ} a two-dimensional Gaussian kernel of prescribed standard deviation σⱼ,
δ(x) is a Dirac function at the pixel x,
α is updated according to α*=α+δα*, where
α* is a column vector of the parameters αⱼ of Compton scattering of the radiation in the part, having been updated,
δα* is a column vector of variation of the parameters αⱼ of Compton scattering of the radiation in the part and is calculated as a δα minimizing the sum of the norms of the squared differences between the projection residuals ρ_{α}⁽ⁿ⁾ and the product of δα by s_{α}⁽ⁿ⁾ for n ranging from 1 to N,

$${δα}^{*} = arg {min}_{δα} {\sum }_{( n )} {‖ {ρ}_{α}^{( n )} - {s}_{α}^{( n )} δα ‖}^{2}$$

where δα is a column vector, s_{α}⁽ⁿ⁾ is a matrix of the sensitivity fields s_{α}_{ⱼ}⁽ⁿ⁾.

According to an embodiment of the invention, P̆⁽ⁿ⁾(x)=u(\hat{P}⁽ⁿ⁾(x)) is the simulated image, obtained by applying the function u(y) to the intensity of each of the pixels x of the computed image \hat{P}⁽ⁿ⁾.

According to an embodiment of the invention N is less than or equal to 1000.

A second subject matter of the invention is a computer program, comprising code instructions for implementing the following steps of a method of non-destructive testing of a part by transmission radiography, when it is executed by a calculator:
receiving of N projections of the part from a transmission radiography device from N different and predetermined angles of view of the part, where N is a given natural integer,
generating of N computed images of the part from a reference model of the part corresponding to the N angles of view and from a vector p of parameters characterizing the projection geometry of the acquisition for the N angles of view at each of several successive iterations,
estimating, by the successive iterations, of the vector p from an initial vector p=pᵢₙᵢ and of at least one of a vector c of parameters from an initial vector c=cᵢₙᵢ and of a vector α of parameters from an initial vector α=αᵢₙᵢ, where the vector c of the parameters accounts for the beam hardening of the radiation in the part and the vector α of the parameters characterizes the Compton scattering of the radiation in the part, by minimizing the sum of the norms of the squared differences between the N projections having been acquired and the N computed images,
processing of the N projections and/or of the N computed images comprising a first processing and/or a second processing,
   the first processing comprising a correction of the beam hardening over the N projections from the vector c having been estimated or a generation of the beam hardening over the N computed images from the vector c having been estimated,
   the second processing comprising a correction of the Compton scattering over the N projections from the vector α having been estimated or a generation of the Compton scattering over the N computed images from the vector α having been estimated,
identifying of defects of the part by comparison of the N projections having been processed with the N computed images having been processed.

A third subject matter of the invention is a device for non-destructive testing of a part by transmission radiography, comprising:
a transmission radiography device, for acquiring of N projections of the part along N different and predetermined angles of view of the part, where N is a given natural integer,
a calculator configured to carry out the following steps:
   generating of N computed images of the part from a reference model of the part corresponding to the N angles of view and from a vector p of parameters characterizing the projection geometry of the acquisition for the N angles of view at each of several successive iterations,
   estimating, by the successive iterations, of the vector p from an initial vector p=pᵢₙᵢ and of at least one of a vector c of parameters from an initial vector c=cᵢₙᵢ and of a vector α of parameters from an initial vector α=αᵢₙᵢ, where the vector c of the parameters accounts for the beam hardening of the radiation in the part and the vector α of the parameters characterizes the Compton scattering of the radiation in the part, by minimizing the sum of the norms of the squared differences between the N acquired projections and the N computed images,
   processing of the N projections and/or of the N computed images comprising a first processing and/or a second processing,
the first processing comprising a correction of the beam hardening over the N projections from the vector c having been estimated or a generation of the beam hardening over the N computed images from the vector c having been estimated, the second processing comprising a correction of the Compton scattering over the N projections from the vector α having been estimated or a generation of the Compton scattering over the N computed images from the vector α having been estimated,
   identifying of defects of the part by comparison of the N projections having been processed with the N computed images having been processed.

The invention will be better understood on reading the following description, given solely by way of non-limiting example with reference to the figures below of the appended drawings.

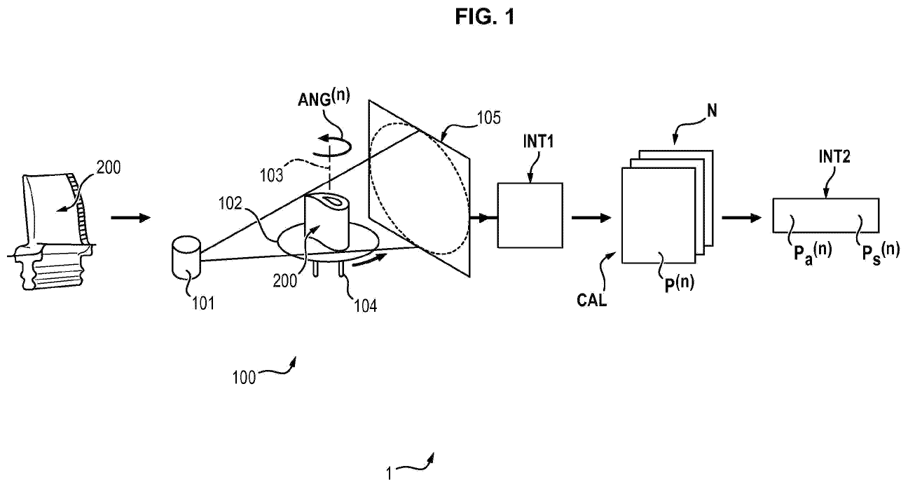

FIG. 1 schematically represents a modular block diagram of a device for non-destructive testing of a part by X-ray radiography according to an embodiment of the invention.

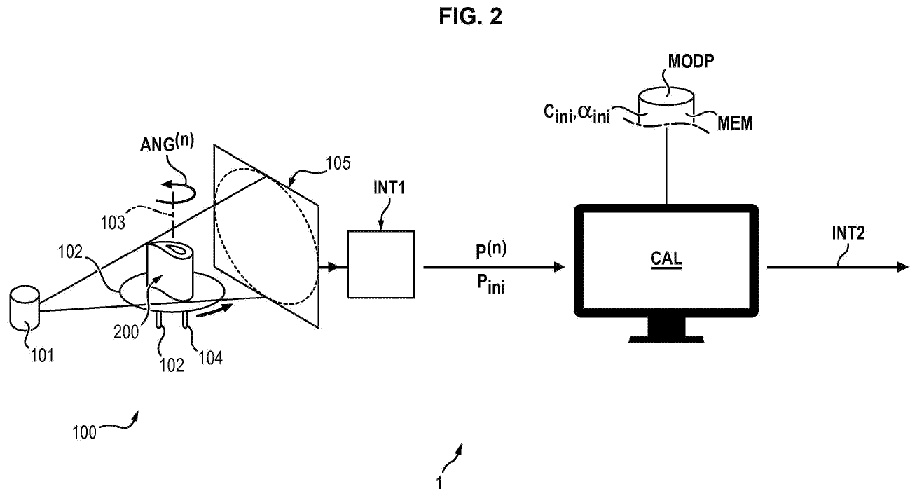

FIG. 2 schematically represents a modular block diagram of a device for non-destructive testing of a part by X-ray radiography according to an embodiment of the invention.

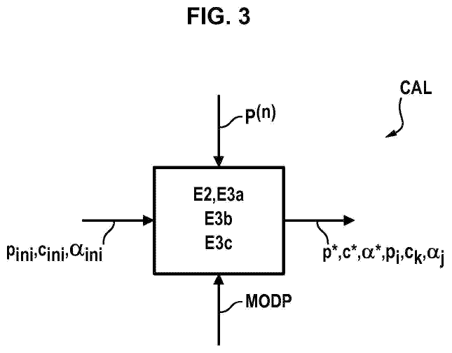

FIG. 3 schematically represents a modular block diagram of a device for non-destructive testing of a part by X-ray radiography according to an embodiment of the invention.

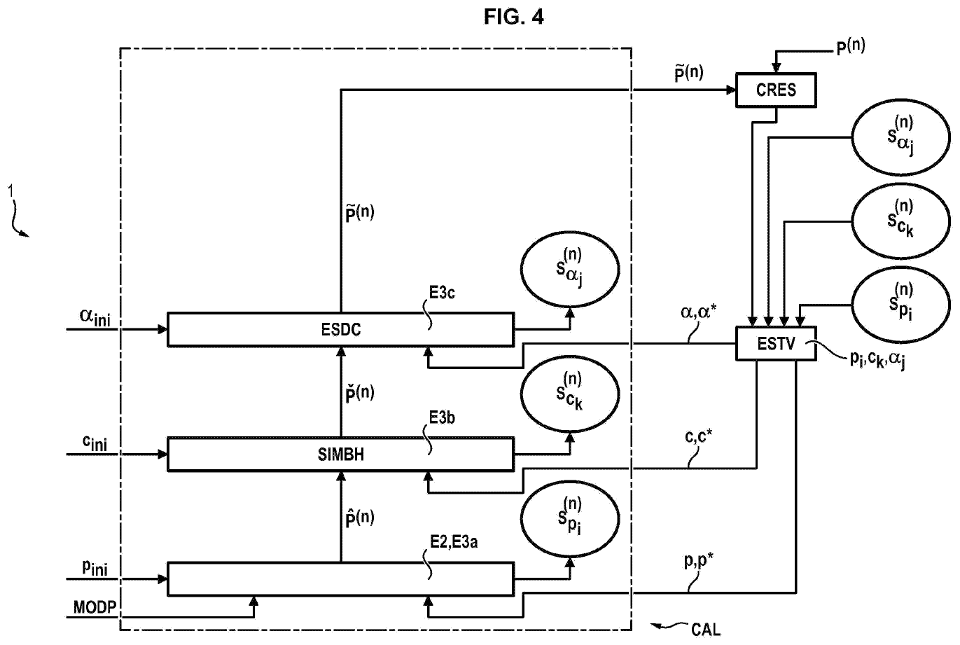

FIG. 4 schematically represents a modular block diagram of a device for non-destructive testing of a part by X-ray radiography according to an embodiment of the invention.

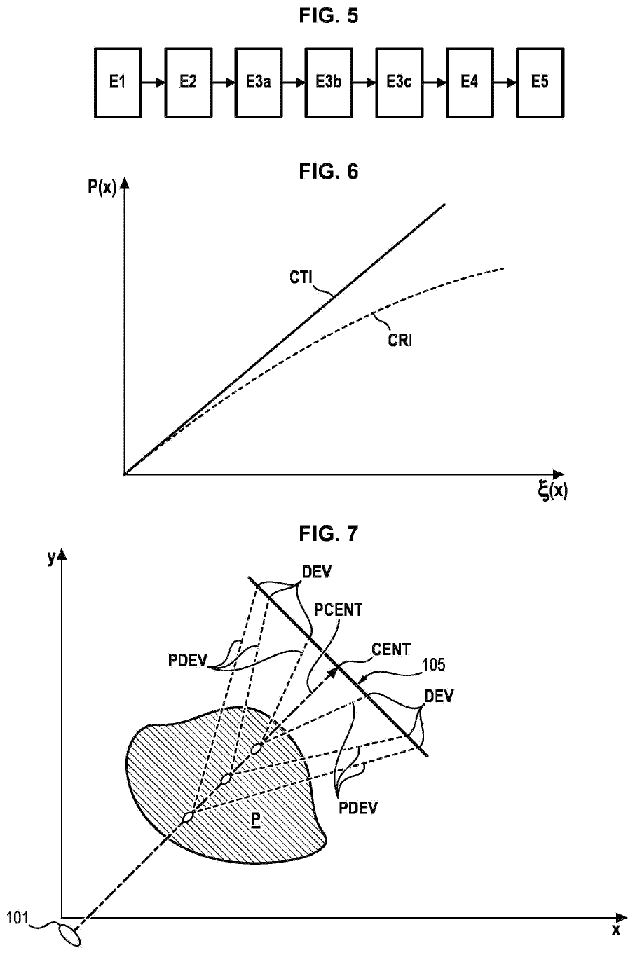

FIG. 5 schematically represents an organizational chart of a method for non-destructive testing of a part by X-ray radiography according to an embodiment of the invention.

FIG. 6 schematically represents a curve of the intensity of the pixels of a projection P(x) in the ideal scenario and in a practical scenario altered by beam hardening artefacts of a projection obtained by a device of the prior art.

FIG. 7 represents an explanatory diagram of Compton scattering during the acquisition of an X-ray projection.

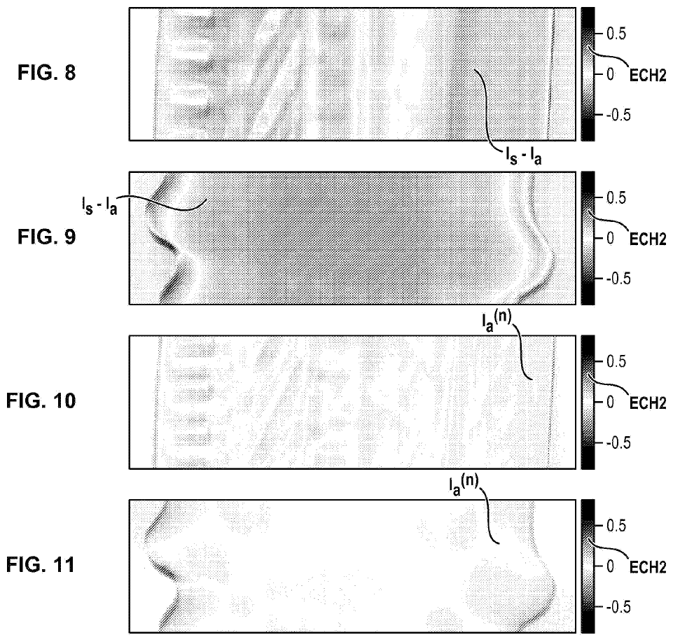

FIG. 8 represents the difference between, firstly, the inverse of the exponential of the intensity of an acquired projection, and secondly, the inverse of the exponential of the intensity of a simulated projection, before correction on a part of a blade airfoil of a turbomachine turbine, obtained by a device of the prior art.

FIG. 9 represents the difference between, firstly, the inverse of the exponential of the intensity of an acquired projection, and secondly, the inverse of the exponential of the intensity of a simulated projection, before correction on a part of a blade root of a turbomachine turbine, obtained by a device of the prior art.

FIG. 10 represents the difference between, firstly, the inverse of the exponential of the intensity of an acquired projection, and secondly, the inverse of the exponential of the intensity of a simulated projection, after correction on a part of the same blade airfoil of a turbomachine turbine as in FIG. 8, obtained by the method, a device and a computer program for the non-destructive testing of a part by X-ray radiography according to an embodiment of the invention.

FIG. 11 represents the difference between, firstly, the inverse of the exponential of the intensity of an acquired projection, and secondly, the inverse of the exponential of the intensity of a simulated projection, after correction on a part of the same blade root of a turbomachine turbine as in FIG. 9, obtained by the method, a device and a computer program for the non-destructive testing of a part by X-ray radiography according to an embodiment of the invention.

As illustrated in FIGS. 1 to 5, the device 1 for non-destructive testing of an actual part 200 comprises a transmission radiography device 100 used to acquire, during the step E1 of the method, a number of projections P⁽ⁿ⁾, also known as raw acquired projections, of the part 200. In the following text, the radiation is X-rays. The radiography device 100 makes it possible to inspect the part 200 under controlled acquisition conditions with a known acquisition geometry and makes it possible to perform transmission imaging of the internal structure of the part 200. In the remainder of the text, the projections P⁽ⁿ⁾ and the images mentioned below are defined by their gray levels (or intensity) for their different pixels x.

In the embodiments described below, the projections P⁽ⁿ⁾ are X-ray images P⁽ⁿ⁾ in X-ray transmission mode, in the method of non-destructive testing of a part by X-ray radiography, the device 1 for non-destructive testing of a part by X-ray radiography and the computer program for non-destructive testing of a part by X-ray radiography.

The part 200 is a mechanical part, and can be without Limitation an aeronautical part, particularly a turbomachine blade (for example of a turbojet engine), for example one of their turbine blades (turbine airfoil), or can be of another kind. The part 200 is made of a material semi-transparent to radiation, here to X-rays, and can be composed of a single material. The part 200 can be a metallic part or a ceramic matrix composite part, or another kind. The method, the device 1 and the computer program for the non-destructive testing of the part by X-ray radiography are used to test the part 200 during its fabrication or during maintenance operations, in order to detect defects in this part, which can for example cause an in-flight failure in the case of an aeronautical part.

The device 1 for non-destructive testing of the part 200 comprises, and the method of non-destructive testing of the part 200 uses, one (or more) calculators CAL. The calculator CAL may be or comprise one or more computers, one or more servers, one or more machines, one or more processors, one or more microprocessors, one or more permanent memories MEM, or one or more random-access memories MEM. The calculator CAL may comprise one or more physical data input interfaces INT1, and one or more physical data output interfaces INT2. This or these physical data input interfaces INT1 may be or comprise one or more computer keyboard, one or more physical data communication ports, one or more touch-sensitive screens, or other kinds. This or these physical data output interfaces INT2 may be or comprise one or more physical data communication ports, one or more touch-sensitive screens, or other kinds. A computer program may be recorded and executed on the calculator CAL of the device 1 for non-destructive testing of the part 200 and comprise code instructions, which when they are executed on it, implement all or part of the method of non-destructive testing of the part 200 according to the invention (comprising the reception of the N projections during step E1).

The X-ray radiography device 100 comprises a source 101 of X-rays, a support 102 on which the part 200 is located, a control mechanism 104 to turn the support 102 and the source 101 with respect to one another 101 about an axis 103 of rotation, which can for example be vertical (for example the source 101 is fixed and the support 102 is rotated about the axis 103), a detector 105 of the X-rays crossing the part 200, the part 200 being therefore located on the path of the X-rays between the source 101 and the detector 105. The source 101, the support 102 and the detector 105 are disposed in a high-power X-ray cabinet. The detector 105 supplies the projections P⁽ⁿ⁾ of the part 200 during the first step E1. The control mechanism 104 is controlled for the acquisition at the N angles ANG⁽ⁿ⁾ of view, different from one another, of the part 200 as regards the X-rays, by the detector 105, of N projections P⁽ⁿ⁾. N is a given natural integer, greater than or equal to 1. The natural integer n ranges from 1 to N and denotes the number of the respective angle ANG⁽ⁿ⁾ of view and therefore the number of the acquired projection P⁽ⁿ⁾. The radiography device 100 thus makes it possible to acquire N projections (i.e. N projections P⁽ⁿ⁾) of the volume of the part 200 from the N angles ANG⁽ⁿ⁾ of view respectively. The N angles ANG⁽ⁿ⁾ of view have been predetermined to be used for the later step E5 of analysis of the part. The long acquisition time of the projections acquired by X-rays leads to the consideration of only a limited number N of acquired projections P⁽ⁿ⁾, less than 1000 or even less than 100, or otherwise. The X-ray radiography device 100 thus supplies all the projections P⁽ⁿ⁾ acquired during step E1.

During a second step E2, after the first step E1, the calculator CAL generates N computed images \hat{P}⁽ⁿ⁾ of the part 200 based on a reference digital model MODP of the part 200, as illustrated in FIGS. 1 to 5. These N computed images \hat{P}⁽ⁿ⁾ correspond to the N angles ANG⁽ⁿ⁾ of view, i.e. adopt the same angle ANG⁽ⁿ⁾ of view as the N projections P⁽ⁿ⁾ respectively. This model MODP is a geometrical reference of the part 200, is recorded in advance in a memory of the calculator CAL and can be, for example, a computer-assisted design (or CAD) model, of the part 200, replicating an ideal defect-free part 200, having an external shape of defined three-dimensional coordinates. This model MODP can take into account the composition of the material of the part 200. At each step E2, the calculator CAL generates N computed images \hat{P}⁽ⁿ⁾ of the part 200 based on the reference model MODP of the part 200 corresponding to the N angles ANG⁽ⁿ⁾ of view and based on a vector p of parameters pi characterizing the geometry of projection of the acquisition for the N angles ANG⁽ⁿ⁾ of view at each of several successive iterations.

The calculator CAL carries out one or more of the steps E3a, E3b, E3c of estimation of multi-view acquired projection artefacts, which will be described below. According to embodiments, the determination of the parameters described below is done by an optimization procedure which makes use of the sensitivity fields to minimize projection residuals.

During the third step E3a, after the first step E1, the calculator CAL estimates the vector p of the parameters pᵢ of the projection geometry of the acquisition of step E1 for the N angles ANG⁽ⁿ⁾ of view, by minimizing the sum of the quadratic norms of the squared differences, computed by the calculator CAL, between the N acquired projections P⁽ⁿ⁾ and the N computed images \hat{P}⁽ⁿ⁾. During the third step E3a the calculator CAL estimates the vector p describing the geometry of the X-ray radiography device 100 with respect to the model MODP of the ideal part 200 (for example its CAD model). The third step E3 makes it possible to accurately determine by the calculator CAL the vector p of the projection geometry used during the acquisition of the projections P⁽ⁿ⁾ by the X-ray radiography device 100. This makes it possible to ensure a more reliable simulation of the images. The third step E3a makes it possible to carry out, during the next iteration of step E2, a geometric registration of the N images \hat{P}⁽ⁿ⁾ computed for the N angles ANG⁽ⁿ⁾ of view by computing the N computed images \hat{P}⁽ⁿ⁾ by projection of the model MODP onto the plane of the detector 105 according to the geometry determined by the vector p of the N acquired projections P⁽ⁿ⁾. The step E3a can be implemented by a simulator SIMX, as represented in FIG. 4. During the third step E3a, the calculator CAL estimates the vector p of the parameters pᵢ of the projection geometry of the acquisition by the successive iterations based on an initial vector p=pᵢₙᵢ.

The vector p of parameters of the projection geometry is used to simulate the computed images \hat{P}⁽ⁿ⁾. Thus, during step E2, use is already being made of the vector pᵢₙᵢ of the parameters of the given initial values of the parameters of the projection geometry during the first iteration; then during the following iterations of step E2 use is made of the estimated values of the vector p. The computed images \hat{P}⁽ⁿ⁾ are subsequently used to estimate the vector c and/or a in step E3a and step E3b and/or E3c. The computed images \hat{P}⁽ⁿ⁾ are not corrected solely in step E4, but also in step E2. Thus, step E2 comprises the regeneration of the computed image \hat{P}⁽ⁿ⁾ at each new iteration with the new vector p*, which has been estimated during the step E3a. The estimate of the vector p during step E3a is an iterative procedure, and therefore at each iteration one uses the best possible estimate (up to convergence) to generate the computed images \hat{P}⁽ⁿ⁾. The vector p is used in step E2 and at each of the iterations of step E3a.

The reproduction or correction of the artefacts is based on the digital simulation of the acquired projections P⁽ⁿ⁾ by an X-ray system. The artefacts are then estimated based on a parametric model (steps E3b, E3c) before being either reproduced (step E4), or corrected (step E4).

The projection parameters pᵢ (such as the angles ANG⁽ⁿ⁾ of projection, distance from the source 101 to the detector 105) make it possible to link the ideal model MODP of the part 200 to the acquired projections P⁽ⁿ⁾ of the part 200 and are thus registration parameters of the ideal model MODP of the part 200 with the acquired projections P⁽ⁿ⁾.

According to an embodiment of the invention, during step E3a, at each iteration the calculator CAL computes (for example via the residuals computer CRES in FIG. 4) the projection residuals ρₚ⁽ⁿ⁾, these residuals being the differences between the observed projections P⁽ⁿ⁾ and the simulated projections \hat{P}⁽ⁿ⁾ according to the equation ρₚ⁽ⁿ⁾=P⁽ⁿ⁾−\hat{P}⁽ⁿ⁾. Based on the first given approximation, written pᵢₙᵢ, of these parameters pᵢ, the calculator CAL estimates (for example by the estimator ESTV in FIG. 4) the vector p* describing the system observed as well as possible, i.e. minimizing the projection residuals ρₚ⁽ⁿ⁾. The sensitivity fields sₚ_{ᵢ}⁽ⁿ⁾ are computed (for example by finite differences, or otherwise) by the calculator CAL according to the following equation:

$${{s}_{{p}_{i}}^{( n )} = \frac{\partial {\hat{P}}^{( n )}}{\partial {p}_{i}} \vert}_{p}$$

and express the effect of the variation of each of the parameters pᵢ on the computed image. The parameters pᵢ of the projection geometry are computed by the calculator CAL by optimization based on the projection residuals ρₚ⁽ⁿ⁾, on the value pᵢₙᵢ, and on the sensitivity fields sₚ_{ᵢ}⁽ⁿ⁾. The calculator CAL computes the optimal variation δp* of the vector p of parameters and updates the vector p according to the following equation:

$${p}^{*} = p + δ {p}^{*}$$

where p* is the updated column vector of the parameters pᵢ of the projection geometry, δp* is the column vector of variation of the parameters pᵢ of the projection geometry and is computed by the calculator CAL as the δp minimizing the sum of the norms of the squared differences between the projection residuals ρₚ⁽ⁿ⁾ and the product of δp by sₚ⁽ⁿ⁾ for n ranging from 1 to N,

$$δ {p}^{*} = arg {min}_{δ p} {\sum }_{( n )} {‖ {ρ}_{p}^{( n )} - {s}_{p}^{( n )} δ p ‖}^{2}$$

where δp is a column vector,
sₚ⁽ⁿ⁾ is the matrix of sensitivity fields sₚ_{ᵢ}⁽ⁿ⁾.
   The number of rows of the matrix sₚ⁽ⁿ⁾ is the number of pixels exploited in the projections P⁽ⁿ⁾, in the computed images \hat{P}⁽ⁿ⁾ and in the residual ρₚ⁽ⁿ⁾. The number of columns of the matrix sₚ⁽ⁿ⁾ is the number of parameters pᵢ.
   The calculator CAL then computes during the step E3a the set of sensitivity fields sₚ_{ᵢ}⁽ⁿ⁾ for n ranging from 1 to N and i ranging from 1 to K₁.
   The estimation of the vector p of parameters pᵢ of the projection geometry for the N angles ANG⁽ⁿ⁾ of view by the calculator CAL is carried out by successive iterations over p which becomes pᵢₙᵢ, to:
compute at each current iteration, based on the vector p of the preceding iteration taking the place of the vector pᵢₙᵢ mentioned above, the sensitivity fields sₚ_{ᵢ}⁽ⁿ⁾ according to the equation mentioned above,
for each current iteration: compute a new δp* and update p according to p*=p+δp*, with δp* computed as δp minimizing the sum of the norms of the squared differences between the projection residuals ρₚ⁽ⁿ⁾ and the product of δp by sₚ⁽ⁿ⁾ for n ranging from 1 to N, according to

$$δ {p}^{*} = arg {min}_{δ p} {\sum }_{( n )} {‖ {ρ}_{p}^{( n )} - {s}_{p}^{( n )} δ p ‖}^{2}$$

until p converges on a better estimate (determined for example by the fact that the norm of the computed difference between the p of the current iteration and the p of the preceding iteration becomes less than a prescribed threshold).

During the fourth step E3b, after the first step E1, the calculator CAL estimates the vector c of the parameters cₖ of calibration of the beam hardening of the X-rays in the part 200 by minimizing the sum of the norms of the squared differences between the N acquired projections P⁽ⁿ⁾ and the N computed images \hat{P}⁽ⁿ⁾, computed by the calculator CAL. Beam hardening refers to the fact that the absorption of a photon by the constituent material of the analyzed part depends on its energy. Low-energy photons are absorbed preferably, compared to those of high energy. So-called beam hardening artefacts emerge from the gap between the actual curve CRI given by the gray level P(x) of the pixels x of a measured projection P⁽ⁿ⁾ and the theoretical curve CTI resulting from the modeling used in the analyses of the projections (Beer-Lambert law), illustrated in FIG. 6. Beam hardening gives rise to a non-linear relationship between the measured intensity P(x) of a projection and the thickness ξ(x) of material crossed (deviation from the Beer-Lambert law) in the case of a single-material part. The thickness ξ(x) is the thickness crossed by the ray before reaching the pixel x. In the case of single-material parts 200, beam hardening artefacts can be exactly corrected by calibration of the beam hardening attenuation. The calculator CAL makes an identification of the calibration function connecting the effective attenuation of the X-rays crossing the part 200 and the length of material crossed in the part 200. The step E3b can be implemented by an X-ray beam hardening simulator SIMBH, as shown in FIG. 4. In step E3b, the calculator CAL estimates, by the successive iterations, the vector c based on an initial vector c=cᵢₙᵢ.

Below is a description of the embodiments of the fourth step E3b. What is described below is carried out at each of the iterations of step E3b.

The calculator CAL calibrates the beam hardening by identifying the function u making the change from \hat{P}{umlaut over (()}n)(x) to P⁽ⁿ⁾(x), namely P⁽ⁿ⁾(x)=u(\hat{P}⁽ⁿ⁾(x)).

According to an embodiment of the invention, the beam hardening calibration is done by application of a piecewise linear function u connecting P⁽ⁿ⁾(x) and \hat{P}⁽ⁿ⁾(x).

According to an embodiment of the invention, the function u is discretized over a base of given form functions φₖ(y) (for example one-dimensional finite elements, or spline functions, or polynomial functions, or others):

$$u ( y ) = {\sum }_{k = 1}^{{K}_{3}} {c}_{k} {φ}_{k} ( y )$$

where K₃ is a given natural integer greater than or equal to 1, k is a natural integer ranging from 1 to K₃, y is a mute variable denoting the gray level (intensity) of a pixel of a reference image \hat{P}⁽ⁿ⁾. The column vector c containing the parameters cₖ quantifies the X-ray beam hardening calibration function for k ranging from 1 to K₃. Based on a given initial estimation cᵢₙᵢ of these parameters, the calculator CAL computes the vector c* describing the observed effect as well as possible.

According to an embodiment of the invention, the calculator CAL computes (for example by finite differences) the sensitivity fields s_{c}_{ₖ}⁽ⁿ⁾ associated with each degree of freedom cₖ:

$${{s}_{{c}_{k}}^{( n )} = \frac{\partial {\breve{P}}^{( n )}}{\partial {c}_{k}} \vert}_{c}$$

based on the vector c=cᵢₙᵢ of the initial given values of the parameters cₖ of calibration of the beam hardening of the X-rays in the part 200, with P̆⁽ⁿ⁾ the simulated image, obtained by applying the function u (with the parameters contained in the vector cᵢₙᵢ) at each of the pixels of \hat{P}⁽ⁿ⁾. The vector cᵢₙᵢ of the initial values is such that u(y)=y. One thus has:

$${\breve{P}}^{( n )} ( x ) = {\sum }_{k = 1}^{{K}_{3}} {c}_{k} {φ}_{k} ( {\hat{P}}^{( n )} ( x ) )$$

The sensitivity fields s_{c}_{ₖ}⁽ⁿ⁾ express the effect of the variation of each of the parameters cₖ on the computed image.

According to an embodiment of the invention, during step E3b, the calculator CAL computes (for example by the residuals computer CRES in FIG. 4) the projection residuals ρ_{c}⁽ⁿ⁾=P⁽ⁿ⁾−P̆⁽ⁿ⁾, these residuals being the differences between the observed projections P⁽ⁿ⁾ and the simulated projections P̆⁽ⁿ⁾. Based on a first given approximation cᵢₙᵢ of the column vector c of parameters cₖ, the calculator CAL estimates (for example by the estimator ESTV in FIG. 4) the vector c* describing the observed system as well as possible, i.e. minimizing the projection residuals ρ_{c}⁽ⁿ⁾. The vector c is computed by the calculator CAL by optimization based on the projection residuals ρ_{c}⁽ⁿ⁾, on the value cᵢₙᵢ, and on the sensitivity fields s_{c}_{ₖ}⁽ⁿ⁾. The calculator CAL computes the optimal variation δc* of the vector c of parameters and updates the vector c according to the following equations:

$${c}^{*} = c + δ {c}^{*}$$

where c* is the updated column vector of the parameters cₖ of X-ray beam hardening in the part 200,
δc* is the column vector of variation of the parameters cₖ of calibration of the beam hardening of the X-rays in the part 200 and is computed as the δc minimizing the sum of the norms of the squared differences between the projection residuals ρ_{c}⁽ⁿ⁾ and the product of δc by s_{c}⁽ⁿ⁾ for n ranging from 1 to N,

$$δ {c}^{*} = arg {min}_{δ c} {\sum }_{( n )} {‖ {ρ}_{c}^{( n )} - {s}_{c}^{( n )} δ c ‖}^{2}$$

where δc is a column vector,
s_{c}⁽ⁿ⁾ is the matrix of sensitivity fields s_{c}_{ₖ}⁽ⁿ⁾.
   The number of rows of the matrix s_{c}⁽ⁿ⁾ is the number of pixels exploited in the projections P⁽ⁿ⁾, in the computed images \hat{P}⁽ⁿ⁾ and in the residual ρ_{c}⁽ⁿ⁾. The number of columns of the matrix s_{c}⁽ⁿ⁾ is the number of parameters cₖ.
   The calculator CAL then computes during step E3b the set of sensitivity fields s_{c}_{ₖ}⁽ⁿ⁾ for n ranging from 1 to N and k ranging from 1 to K₃.
   The estimation of the vector c of the parameters cₖ of calibration of the beam hardening by the calculator CAL is carried out by successive iterations over c which becomes cᵢₙᵢ, to:
compute at each current iteration, based on the vector c of the preceding iteration taking the place of the vector cᵢₙᵢ mentioned above, the sensitivity fields s_{c}_{ₖ}⁽ⁿ⁾ according to the equation mentioned above,
for each current iteration: compute a new δc* and update c according to c*=c+δc*, with δc* computed as the δc minimizing the sum of the norms of the squared differences between the projection residuals ρ_{c}⁽ⁿ⁾ and the product of δc by s_{c}⁽ⁿ⁾ for n ranging from 1 to N, according to

$$δ {c}^{*} = arg {min}_{δ c} {\sum }_{( n )} {‖ {ρ}_{c}^{( n )} - {s}_{c}^{( n )} δ c ‖}^{2}$$

until c converges on a better estimate (determined for example by the fact that the norm of the difference computed between the c of the current iteration and the c of the preceding iteration becomes less than a given threshold).

During the fifth step E3c, after the first step E1, the calculator CAL estimates the vector α of the parameters αⱼ of Compton scattering of the X-rays in the part 200 by minimizing the sum of the norms of the squared differences, computed by the calculator CAL, between the N acquired projections P⁽ⁿ⁾ and the N simulated images P̆⁽ⁿ⁾, having been computed based on the N computed images \hat{P}⁽ⁿ⁾. The Compton scattering parameters αⱼ represent the effect of the Compton scattering on the acquired projections P⁽ⁿ⁾. As illustrated in FIG. 7, Compton scattering consists in the interaction of a photon of the X-ray with a free electron (or an electron weakly attached to its atom) of the inspected part 200, causing the deviation of the photon from its initial trajectory. Reaching the detector 105, the photon thus scattered and deviated PDEV gives rise to an increase in the measured intensity (known as secondary signal P_{sec}⁽ⁿ⁾ in the remainder of the text) in the area DEV located around the point of direct and central impact CENT of the primary ray PCENT, and a reduction of this intensity (called primary signal Pₚᵣᵢₘ⁽ⁿ⁾ in the remainder of the text) at this point of impact CENT, creating in the projections a blur degrading the metrological analysis. Unlike the known methods using a direct correction of the Compton effect by a deconvolution operation, which is numerically unstable, rendering these reprocessed radiographies unreliable, the step E3c makes provision for reproducing this Compton scattering effect on simulated images, to allow them to be compared with the acquired projections. The step E3c can be implemented by a Compton scattering estimator ESDC, as represented in FIG. 4. During step E3c, the calculator CAL estimates, by successive iterations, the vector α based on an initial vector α=αᵢₙᵢ. What is described below is carried out for each iteration of step E3c.

According to an embodiment of the invention, each acquired projection P⁽ⁿ⁾ is modelled by the calculator CAL as the sum of two components: the primary signal Pₚᵣᵢₘ⁽ⁿ⁾ coming from photons crossing the object without Compton scattering but undergoing absorption by the constituent atoms of the material (photoelectric effect); and the secondary signal P_{sec}⁽ⁿ⁾ which corresponds to the contribution of the photons scattered by Compton scattering from the part 200, according to the following equation:

$${P}^{( n )} = {P}_{p r i m}^{( n )} + {P}_{sec}^{( n )}$$

The secondary, or scattered, signal, P_{sec}⁽ⁿ⁾ is computed by the calculator CAL as the result of the convolution of the primary signal Pₚᵣᵢₘ⁽ⁿ⁾ with a parametric kernel K:

$${P}^{( n )} = {P}_{p r i m}^{( n )} + {P}_{p r i m}^{( n )} * K$$

The calculator CAL computes the parametric kernel K as a weighted sum of two-dimensional Gaussians g_{σ} of different widths to one another (different standard deviations σ to one another):

$$K ( x ) = {\sum }_{j = 1}^{{K}_{2}} {α}_{j} ( {ℊ}_{{σ}_{j}} ( x ) - δ ( x ) )$$

where K₂ is a given natural integer greater than or equal to 1,
j is a natural integer ranging from 1 to K₂,
g_{σ} a two-dimensional Gaussian kernel of given standard deviation σ (following a sequence σⱼ), and δ(x) is the Dirac function at the pixel x.
   In a variant, the parameters αⱼ of the Gaussian kernel g_{σ}_{ⱼ} may be identified experimentally or via Monte-Carlo simulations.

According to an embodiment of the invention, by identifying the primary signal Pₚᵣᵢₘ⁽ⁿ⁾ on the digitally simulated images P̆⁽ⁿ⁾, the calculator CAL computes the vector α* that best approximates the observed Compton scattering. α* is the column vector of the parameters αⱼ of Compton scattering of the X-rays in the part 200, for j ranging from 1 to K₂.

Based on a vector αᵢₙᵢ of the given initial values of the parameters αⱼ of Compton scattering of the X-rays in the part 200, the calculator CAL computes images \tilde{P}⁽ⁿ⁾=P̆⁽ⁿ⁾+P̆⁽ⁿ⁾*K based on the simulated images P̆⁽ⁿ⁾, obtained based on the N computed images \hat{P}⁽ⁿ⁾, according to the equation:

$${\tilde{P}}^{( n )} = {\breve{P}}^{( n )} + {\breve{P}}^{( n )} * K$$

where the scattered signal P̆⁽ⁿ⁾*K is simulated and added to the images P̆⁽ⁿ⁾ such as to generate the images \tilde{P}⁽ⁿ⁾. The calculator CAL thus computes the set of simulated N images P̆⁽ⁿ⁾ during step E3c.

According to an embodiment of the invention, P̆⁽ⁿ⁾(x)=u(\hat{P}⁽ⁿ⁾(x)) is the image obtained by applying the function u to the intensity (gray level) of each of the pixels x of the computed image \hat{P}⁽ⁿ⁾. Of course, the simulated images P̆⁽ⁿ⁾ may be obtained in another way based on the N computed images \hat{P}⁽ⁿ⁾, in the case where step E3c is implemented without step E3b.

The vector αᵢₙᵢ of the given initial values of the parameters αⱼ of Compton scattering is such that \tilde{P}⁽ⁿ⁾=P̆⁽ⁿ⁾ for αᵢₙᵢ.

According to an embodiment of the invention, during step E3c, the calculator CAL computes (for example by the residuals calculator CRES in FIG. 4) the projection residuals ρ_{α}⁽ⁿ⁾, these projection residuals ρ_{α}⁽ⁿ⁾ being the differences between the acquired projections P⁽ⁿ⁾ and the simulated projections \tilde{P}⁽ⁿ⁾ according to the equation:

$${p}_{α}^{( n )} = {P}^{( n )} - {\tilde{P}}^{( n )}$$

Based on the first given approximation of the vector α of parameters, written αᵢₙᵢ, the calculator CAL estimates (for example by the estimator ESTV in FIG. 4) the vector α* describing the observed system as well as possible, i.e. minimizing the projection residuals ρ_{α}⁽ⁿ⁾.

According to an embodiment of the invention, the calculator CAL computes (for example by finite differences) the sensitivity fields s_{α}_{ⱼ}⁽ⁿ⁾, associated with each degree of freedom αⱼ:

$${{s}_{{α}_{j}}^{( n )} = \frac{\partial {\tilde{P}}^{( n )}}{\partial {α}_{j}} \vert}_{α}$$

based on the column vector αᵢₙᵢ of the given initial values of the parameters αⱼ of Compton scattering of the X-rays in the part 200.
The parameters αⱼ of Compton scattering of the X-rays in the part 200 are computed by the calculator CAL by optimization based on the projection residuals ρ_{α}_{ᵢₙᵢ}⁽ⁿ⁾, on the value αᵢₙᵢ, and on the sensitivity fields s_{α}_{ⱼ}⁽ⁿ⁾).

The calculator CAL computes the optimal variation δα* of the vector α of parameters and updates the vector α according to the following equation:

$${α}^{*} = α + {δα}^{*}$$

where δα* is the column vector of variation at least of the parameters αⱼ of Compton scattering of the X-rays in the part 200 and is computed as the δα minimizing the sum of the norms of the squared differences between the projection residuals ρ_{α}⁽ⁿ⁾ and the product of δα by s_{α}⁽ⁿ⁾ for n ranging from 1 to N,

$${δα}^{*} = arg {min}_{δα} {\sum }_{( n )} {‖ {ρ}_{α}^{( n )} - {s}_{α}^{( n )} δα ‖}^{2}$$

where δα is a column vector,
s_{α}⁽ⁿ⁾ is the matrix at least of the sensitivity fields s_{α}_{ⱼ}⁽ⁿ⁾.
The number of rows of the matrix s_{α}⁽ⁿ⁾ is the number of pixels exploited in the projections P⁽ⁿ⁾, in the computed images \hat{P}⁽ⁿ⁾ and in the residual ρ_{α}⁽ⁿ⁾. The number of columns of the matrix s_{α}⁽ⁿ⁾ is the number of parameters αⱼ.
The calculator CAL then computes during step E3c the set of sensitivity fields s_{α}⁽ⁿ⁾ for n ranging from 1 to N and j ranging from 1 to K₁.
The estimation of the vector α of the parameters αⱼ of Compton scattering of the X-rays by the calculator CAL is done by successive iterations over a which becomes αᵢₙᵢ, to:
compute at each current iteration, based on the vector α of the preceding iteration taking the place of the vector αᵢₙᵢ mentioned above the sensitivity fields s_{α}_{ⱼ}⁽ⁿ⁾ according to the equation mentioned above,
for each current equation: compute a new δα* and update a according to α*=α+δα*, with δα* computed as the δα minimizing the sum of the norms of the squared differences between the projection residuals ρ_{α}⁽ⁿ⁾ and the product of δα by s_{α}⁽ⁿ⁾ for n ranging from 1 to N, according to

$${δα}^{*} = arg {min}_{δα} {\sum }_{( n )} {‖ {ρ}_{α}^{( n )} - {s}_{α}^{( n )} δα ‖}^{2}$$

until α converges on a better estimate (determined for example by the fact that the norm of the computed difference between the α of the current iteration and the α of the preceding iteration becomes less than a given threshold).

According to an embodiment of the invention, N is less than or equal to 1000 or to 100 or to 50 or to 10. This is an expression of the small number of acquired projections P⁽ⁿ⁾ in spite of which the invention is capable of working. This number is less than the numbers of acquired projections required in the prior art for the tomographic reconstruction of the part 200.

During the seventh step E4, after the iterations of step E3a and of step E3b and/or E3c, the calculator CAL processes the N projections P⁽ⁿ⁾ obtained in step E1 and/or the N computed images \hat{P}⁽ⁿ⁾, having been obtained after the iterations of step E2. The calculator CAL carries out a first processing and/or a second processing.

The first processing comprises a correction of the beam hardening over the N projections P⁽ⁿ⁾ based on the vector c having been estimated or a generation of the beam hardening over the N computed images \hat{P}⁽ⁿ⁾ based on the vector c having been estimated.

The second processing comprises a correction of the Compton scattering over the N projections P⁽ⁿ⁾ based on the vector α having been estimated or a generation of the Compton scattering over the N computed images \hat{P}⁽ⁿ⁾ based on the vector α having been estimated.

The calculator thus obtains N acquired projections Pₐ⁽ⁿ⁾, which are equal to or corrected based on the N acquired projections P⁽ⁿ⁾ of the part 200, and N simulated images Pₛ⁽ⁿ⁾, which are equal to or generated based on the N computed images \hat{P}⁽ⁿ⁾ of the part 200, these acquired projections Pₐ⁽ⁿ⁾ being directly comparable to the N simulated images Pₛ⁽ⁿ⁾, to then be able to carry out the analysis of the part 200 during step E5.

For example, during step E2 the calculator CAL first generates the N computed images \hat{P}⁽ⁿ⁾ by applying to them the geometric registration for the N angles ANG⁽ⁿ⁾ of view, and does so by using the projection parameters pᵢ to simulate the N computed images \hat{P}⁽ⁿ⁾. It is these computed images \hat{P}⁽ⁿ⁾, thus modified (registered), which are used as computed images \hat{P}⁽ⁿ⁾ in the processing below. This modification by registration using the projection parameters pᵢ is done beforehand on the N computed images \hat{P}⁽ⁿ⁾ in the first and second embodiments of step E4, described below.

According to a first embodiment of step E4, the calculator CAL corrects the acquired projections P⁽ⁿ⁾ by applying to them the inverse of the function u depending on the parameters cₖ of calibration of the beam hardening of the X-rays at each of the pixels of P⁽ⁿ⁾ (to thus make a correction of the beam hardening), to obtain the N corrected acquired projections Pₐ⁽ⁿ⁾ according to the following equation:

$${P}_{a}^{( n )} = {u}^{- 1} ( {P}^{( n )} )$$

The calculator CAL computes the function u depending on the parameters cₖ of calibration of the beam hardening of the X-rays according to the following equation:

$$u ( y ) = {\sum }_{k = 1}^{{K}_{3}} {c}_{k}^{*} {φ}_{k} ( y )$$

where c*k denotes the parameters cₖ of calibration of the beam hardening of X-rays, contained in the vector c* and having been computed.
The calculator CAL processes the N computed images \hat{P}⁽ⁿ⁾ by convolving this with the kernel δ+K having been computed as a function of the Compton scattering parameters αⱼ (reproduction of Compton scattering over the N computed images \hat{P}⁽ⁿ⁾), to obtain the N simulated images Pₛ⁽ⁿ⁾ according to the following equations:

$${P}_{s}^{( n )} = {\hat{P}}^{( n )} * ( δ + K )$$

$$K = {\sum }_{j = 1}^{{K}_{2}} {α}_{i}^{*} ( {g}_{{σ}_{j}} - δ )$$

where α*ⱼ denotes the Compton scattering parameters αⱼ, contained in the vector α* and having been computed.

According to a second embodiment of step E4, the calculator CAL computes the acquired projections Pₐ⁽ⁿ⁾ according to the following equation:

Pₐ⁽ⁿ⁾=P⁽ⁿ⁾

The calculator processes the N computed images \hat{P}⁽ⁿ⁾, by applying to them the function u (computed using the computation described above) depending on the parameters cₖ of calibration of the beam hardening of the X-rays (to thus reproduce the beam hardening), then by convolving them with the kernel δ+K having been computed (computed using the computation described above) as a function of the parameters αⱼ of Compton scattering (reproduction of the Compton scattering on the N computed images \hat{P}⁽ⁿ⁾), to obtain the N simulated images Pₛ⁽ⁿ⁾ according to the following equations:

$${P}_{s}^{( n )} = ( u ( {\hat{P}}^{( n )} ) ) * ( δ + K )$$

During the eighth step E5 of analysis of the actual part 200, after step E4, the calculator CAL identifies the defects of the part 200 by comparison of the N processed projections P⁽ⁿ⁾ with the N processed computed images \hat{P}⁽ⁿ⁾. The calculator CAL identifies the defects of the part 200 by comparison of the N acquired projections Pₐ⁽ⁿ⁾ with the N simulated images Pₛ⁽ⁿ⁾ according to one of the embodiments described above. The calculator CAL carries out an identification of the defects of the part by comparison of the acquired P⁽ⁿ⁾ and simulated \hat{P}⁽ⁿ⁾ images having taken into account the correction or processing either on some of these or on others of these.

The calculator CAL computes N projection residuals ρ⁽ⁿ⁾, equal to the difference between the acquired projections Pₐ⁽ⁿ⁾ and the simulated images Pₛ⁽ⁿ⁾ according to the equation:

$${ρ}^{( n )} = {P}_{a}^{( n )} - {P}_{s}^{( n )}$$

The calculator CAL records in the memory MEM the N acquired projections Pₐ⁽ⁿ⁾ and/or the N simulated images Pₛ⁽ⁿ⁾ and/or the N projection residuals ρ⁽ⁿ⁾. The calculator CAL analyzes these N projection residuals ρ⁽ⁿ⁾ in order to identify defects inherent to the inspected part 200. The calculator CAL can supply, via the output interface INT2, these N projection residuals ρ⁽ⁿ⁾ and/or the defects identified based on these N projection residuals ρ⁽ⁿ⁾. The calculator CAL can supply, via the output interface INT2, a certificate of validity or invalidity of the part, determined by the calculator CAL based on the N projection residuals ρ⁽ⁿ⁾. The calculator CAL or the user can, on the basis of the N acquired projections Pₐ⁽ⁿ⁾ and/or of the N simulated images Pₛ⁽ⁿ⁾ and/or of the N projection residuals ρ⁽ⁿ⁾, evaluate the part 200 as non-valid since it has too many defects, or validate the part 200 as being valid since it does not have too many defects.

According to an embodiment of the invention, the vector p groups one after the other all the K₁ parameters pᵢ of the projection geometry, the K₃ parameters cₖ of beam hardening of the radiation in the part 200 and the K₂ parameters αⱼ of Compton scattering of the radiation, and thus has a dimension of K₁+K₂+K₃. Correspondingly, the vector sₚ⁽ⁿ⁾ groups one after the other all the K₁ sensitivity fields sₚᵢ⁽ⁿ⁾, the K₃ sensitivity fields s_{c}_{ₖ}⁽ⁿ⁾ and the K₂ sensitivity fields s_{α}_{ⱼ}⁽ⁿ⁾ and thus has a dimension of K₁+K₂+K₃. Correspondingly, the vector δp groups one after the other all the variations of the K₁ parameters pᵢ of the projection geometry, the K₃ parameters cₖ of beam hardening of the radiation in the part 200 and the K₂ parameters αⱼ of Compton scattering of the radiation, and thus has a dimension of K₁+K₂+K₃.

FIG. 10 shows an example of the difference between, on the one hand, the image of corrected acquired intensity Iₐ⁽ⁿ⁾=I₀ exp(−Pₐ⁽ⁿ⁾) having been obtained according to the invention based on the acquired projection P⁽ⁿ⁾, where I₀ is a given setting based on the acquired projections P⁽ⁿ⁾, and, on the other hand, the corrected simulated image of intensity Iₛ⁽ⁿ⁾=exp(Pₛ⁽ⁿ⁾) having been obtained based on the simulated projection P⁽ⁿ⁾ for a blade airfoil of a turbomachine turbine. FIG. 11 shows an example of the difference between, on the one hand, the corrected acquired image of intensity Iₐ⁽ⁿ⁾=I₀ exp(−Pₐ⁽ⁿ⁾) having been obtained according to the invention based on the acquired projection P⁽ⁿ⁾, where I₀ is a given setting based on the N acquired projections P(n), and, on the other hand, the simulated image of intensity Iₛ⁽ⁿ⁾=exp(Pₛ⁽ⁿ⁾) having been obtained based on the simulated projection Pₛ⁽ⁿ⁾ for a blade root of a turbomachine turbine. FIGS. 10 and 11 show that the analysis of the part 200 is simplified by the invention taking into account the artefacts. FIGS. 8 and 9 show Iₛ−Iₐ, with no correction on Iₐ, and when Iₛ is generated with pᵢₙᵢ, cᵢₙᵢ and αᵢₙᵢ. FIGS. 10 and 11 show Iₛ−Iₐ, without correction on Iₐ, and when Iₛ is generated with p*, c* and α*.

In the case of the combination of steps E3a, E3b and E3c, the fact of taking into account the knowledge of the acquisition system (cabin and part, step E3a) and coupling it with a suitable image processing algorithmic method E3a, E3b, E3c allows significant gains in the quality of the information contained in the images produced by the system and in those reproduced by simulation, and therefore of their difference. This allows the estimation of the artefacts (1) of beam hardening and (2) of Compton scattering, in the context of the analysis of aeronautical parts based on a limited number of multi-view projections. Step E3a allows the estimation of geometrical parameters making it possible to connect the model MODP of the ideal part with the acquired projections of the part to be tested. This step E3a makes it possible to find the parameters with the aim, in particular, of using them to digitally simulate the projections and reproduce artefacts in the simulated images. The invention also allows in step E4, either to correct the artefacts due to beam hardening (E3b) in the acquired projections, or to reproduce them in the simulated images; and to reproduce the artefacts due to Compton scattering (E3c) in the simulated images or to correct them in the acquired projections. The image acquisition system and the algorithmic sequence improve the reliability of the validation and of the evaluation of indicators of material health and of indicators of the three-dimensional geometry of the part 200 based on a limited number N of radiographic views by X-ray.

According to an embodiment of the invention, the method, the device and the program according to the invention can be implemented over one or more regions of interest, selected by a selection module of the calculator CAL, in the projection P⁽ⁿ⁾.

Of course, the embodiments, features, possibilities and examples described above may be combined with one another or be selected independently of one another.

1-8. (canceled)

9. A method of non-destructive testing of a part by transmission radiography, comprising the following steps, executed by a calculator:
acquiring of N projections of the part using a transmission radiography device from N different and predetermined angles of view of the part, where N is a given natural integer, generating of N computed images of the part from a reference model of the part corresponding to the N angles of view and from a vector p of parameters characterizing a projection geometry of acquisition for the N angles of view at each of several successive iterations,
estimating, by the successive iterations, of the vector p from an initial vector p=pᵢₙᵢ and of at least one of a vector c of parameters from an initial vector c=cᵢₙᵢ and of a vector α of parameters from an initial vector α=αᵢₙᵢ, where the vector c of the parameters accounts for beam hardening of radiation in the part and the vector α of the parameters characterizes Compton scattering of the radiation in the part, by minimizing the sum of the norms of the squared differences between the N projections having been acquired and the N computed images,
processing of the N projections and/or of the N computed images comprising a first processing and/or a second processing,
the first processing comprising a correction of the beam hardening over the N projections from the vector c having been estimated or a generation of the beam hardening over the N computed images from the vector c having been estimated,
the second processing comprising a correction of the Compton scattering over the N projections from the vector α having been estimated or a generation of the Compton scattering over the N computed images from the vector α having been estimated,
identifying of defects of the part by comparison of the N projections having been processed with the N computed images having been processed.

10. The method as claimed in claim 9, comprising at each iteration estimating of the vector p of the parameters pᵢ of the projection geometry of the acquisition for the N angles of view by the calculator, the estimating comprising:
computing of projection residuals ρₚ⁽ⁿ⁾=P⁽ⁿ⁾−\hat{P}⁽ⁿ⁾ from the initial vector p=pᵢₙᵢ of initial values,
computing of sensitivity fields sₚ_{ᵢ}⁽ⁿ⁾ according to
$${s}_{{p}_{i}}^{( n )} = \frac{\partial {\hat{P}}^{( n )}}{\partial {p}_{i}} {\vert}_{p}$$
from the initial vector p=pᵢₙᵢ of the initial values,
where
\hat{P}⁽ⁿ⁾ are the N computed images for the N angles of view,
P⁽ⁿ⁾ are the N projections having been acquired of the part,
p is a column vector of the parameters pᵢ of the projection geometry,
pᵢₙᵢ is a column vector of the initial values of the parameters pᵢ of the projection geometry,
n is a natural integer denoting the number of the angle of view and ranging from 1 to N,
p is updated according to p*=p+δp*, where
p* is a column vector of the parameters pᵢ of the projection geometry having been updated,
δp* is a column vector of variation of the parameters pᵢ of the projection geometry and is calculated as a δp minimizing the sum of the norms of the squared differences between the projection residuals ρₚ⁽ⁿ⁾ and the product of δp by sₚ⁽ⁿ⁾ for n ranging from 1 to N,
$$δ {p}^{*} = arg {min}_{δ p} {\sum }_{( n )} {‖ {ρ}_{p}^{( n )} - {s}_{p}^{( n )} δ p ‖}^{2}$$
where δp is a column vector, sₚ⁽ⁿ⁾ is a matrix of the sensitivity fields sₚᵢ⁽ⁿ⁾.

11. The method as claimed in claim 9, comprising at each iteration estimating of the vector c of the parameters cₖ of calibration of the beam hardening of the radiation in the part by the calculator, the estimating comprising:
computing of projection residuals ρ_{c}⁽ⁿ⁾=P⁽ⁿ⁾−P̆⁽ⁿ⁾ from the initial vector c=cᵢₙᵢ of initial values,
computing of sensitivity fields s_{c}_{ₖ}⁽ⁿ⁾ according to
$${s}_{{c}_{k}}^{( n )} = \frac{\partial {{P}^{⌣}}^{( n )}}{\partial {c}_{k}} {\vert}_{c}$$
from the initial vector c=cᵢₙᵢ of the initial values,
where P̆⁽ⁿ⁾(x)=u(\hat{P}⁽ⁿ⁾(x)) is an image obtained by applying a function u(y) to an intensity y of each of pixels x of \hat{P}⁽ⁿ⁾,
\hat{P}⁽ⁿ⁾ are the N computed images for the N angles of view,
P⁽ⁿ⁾ are the N projections having been acquired of the part,
c is a column vector of the parameters cₖ of calibration of the beam hardening,
cᵢₙᵢ is a column vector of the initial values of the parameters cₖ of calibration of the beam hardening of the radiation in the part,
φₖ(y) is a base of given form functions,
$$u ( y ) = {\sum }_{k = 1}^{{K}_{3}} {c}_{k} {φ}_{k} ( y )$$
K₃ is a given natural integer greater than or equal to 1,
k is a natural integer ranging from 1 to K₃,
c is updated according to c*=c+δc*, where
c* is a column vector of the parameters cₖ of calibration of the beam hardening of the radiation in the part, having been updated,
δc* is a column vector of variation of the parameters cₖ of calibration of the beam hardening of the radiation in the part and is computed as a δc minimizing the sum of the norms of the squared differences between the projection residuals ρ_{c}⁽ⁿ⁾ and the product of δc by s_{c}⁽ⁿ⁾ for n ranging from 1 to N,
$$δ {c}^{*} = arg {min}_{δ c} {\sum }_{( n )} {‖ {ρ}_{c}^{( n )} - {s}_{c}^{( n )} δ c ‖}^{2}$$
where δc is a column vector, s_{c}⁽ⁿ⁾ is a matrix of the sensitivity fields s_{c}_{ₖ}⁽ⁿ⁾.

12. The method as claimed in claim 9, comprising at each iteration estimating of the vector α of the parameters αⱼ of Compton scattering of the radiation in the part by the calculator, the estimating comprising:
computing of projection residuals ρ_{α}⁽ⁿ⁾=P⁽ⁿ⁾−\tilde{P}⁽ⁿ⁾ from the initial vector α=αᵢₙᵢ of the initial values,
computing of sensitivity fields s_{α}_{ⱼ}⁽ⁿ⁾ according to
$${s}_{{α}_{j}}^{( n )} = \frac{\partial {\tilde{P}}^{( n )}}{\partial {α}_{j}} {\vert}_{α}$$
from the initial vector α=αᵢₙᵢ of the initial values,
where P⁽ⁿ⁾ are the N projections having been acquired of the part,
\hat{P}⁽ⁿ⁾ are the N computed images for the N angles of view,
\tilde{P}⁽ⁿ⁾=P̆⁽ⁿ⁾+P̆⁽ⁿ⁾*K is an image obtained by convolution of simulated images P̆⁽ⁿ⁾, having been obtained from at least the N computed images \hat{P}⁽ⁿ⁾, with a kernel δ+K,
α is a column vector of the parameters αⱼ of Compton scattering of the radiation in the part,
αᵢₙᵢ is a column vector of the initial values of the parameters αⱼ of Compton scattering of the radiation in the part,
K is a convolution kernel defined by
$$K ( x ) = {\sum }_{j = 1}^{{K}_{2}} {α}_{j} ( {g}_{{σ}_{j}} ( x ) - δ ( x ) )$$
K₂ is a prescribed natural integer greater than or equal to 1,
j is a natural integer ranging from 1 to K₂,
g_{σ}_{ⱼ} a two-dimensional Gaussian kernel of prescribed standard deviation σj,
δ(x) is a Dirac function at the pixel x,
α is updated according to α*=α+δα*, where
α* is a column vector of the parameters αⱼ of Compton scattering of the radiation in the part, having been updated,
δα* is a column vector of variation of the parameters αⱼ of Compton scattering of the radiation in the part and is calculated as a δα minimizing the sum of the norms of the squared differences between the projection residuals ρ_{α}⁽ⁿ⁾ and the product of δα by s_{α}⁽ⁿ⁾ for n ranging from 1 to N,
$$δ {α}^{*} = arg {min}_{δ α} {\sum }_{( n )} {‖ {ρ}_{α}^{( n )} - {s}_{α}^{( n )} δα ‖}^{2}$$
where δα is a column vector, s_{α}⁽ⁿ⁾ is a matrix of the sensitivity fields s_{α}_{ⱼ}⁽ⁿ⁾.

13. The method as claimed in claim 11,
comprising at each iteration estimating of the vector α of the parameters αⱼ of Compton scattering of the radiation in the part by the calculator, the estimating comprising:
computing of projection residuals ρ_{α}⁽ⁿ⁾=P⁽ⁿ⁾−\tilde{P}⁽ⁿ⁾ from the initial vector α=αᵢₙᵢ of the initial values,
computing of sensitivity fields s_{α}_{ⱼ}⁽ⁿ⁾ according to
$${s}_{{α}_{j}}^{( n )} = \frac{\partial {\tilde{P}}^{( n )}}{\partial {α}_{j}} {\vert}_{α}$$
from the initial vector α=αᵢₙᵢ of the initial values,
where P⁽ⁿ⁾ are the N projections having been acquired of the part,
\hat{P}⁽ⁿ⁾ are the N computed images for the N angles of view,
\tilde{P}⁽ⁿ⁾=P̆⁽ⁿ⁾+P̆⁽ⁿ⁾*K is an image obtained by convolution of simulated images P̆⁽ⁿ⁾, having been obtained from at least the N computed images \hat{P}⁽ⁿ⁾, with a kernel δ+K,
α is a column vector of the parameters αⱼ of Compton scattering of the radiation in the part,
αᵢₙᵢ is a column vector of the initial values of the parameters αⱼ of Compton scattering of the radiation in the part,
K is a convolution kernel defined by
$$K ( x ) = {\sum }_{j = 1}^{{K}_{2}} {α}_{j} ( {g}_{{σ}_{j}} ( x ) - δ ( x ) )$$
K₂ is a prescribed natural integer greater than or equal to 1,
j is a natural integer ranging from 1 to K₂,
g_{σ}_{ⱼ} a two-dimensional Gaussian kernel of prescribed standard deviation σj,
δ(x) is a Dirac function at the pixel x,
α is updated according to α*=α+δα*, where
α* is a column vector of the parameters αⱼ of Compton scattering of the radiation in the part, having been updated,
δα* is a column vector of variation of the parameters αⱼ of Compton scattering of the radiation in the part and is calculated as a δα minimizing the sum of the norms of the squared differences between the projection residuals ρ_{α}⁽ⁿ⁾ and the product of δα by s_{α}⁽ⁿ⁾ for n ranging from 1 to N,
$${δα}^{*} = arg {min}_{δ α} {\sum }_{( n )} {‖ {ρ}_{α}^{( n )} - {s}_{α}^{( n )} δα ‖}^{2}$$
where δα is a column vector, s_{α}⁽ⁿ⁾ is a matrix of the sensitivity fields s_{α}_{ⱼ}⁽ⁿ⁾,
wherein P̆⁽ⁿ⁾(x)=u(\hat{P}⁽ⁿ⁾(x)) is the simulated image, obtained by applying the function u(y) to the intensity of each of the pixels x of the computed image \hat{P}⁽ⁿ⁾.

14. The method as claimed in claim 9, characterized in that N is less than or equal to 1000.

15. A computer program, comprising code instructions for implementing the following steps of a method of non-destructive testing of a part by transmission radiography, when it is executed by a calculator:
receiving of N projections of the part from a transmission radiography device from N different and predetermined angles of view of the part, where N is a given natural integer,
generating of N computed images of the part from a reference model of the part corresponding to the N angles of view and from a vector p of parameters characterizing the projection geometry of the acquisition for the N angles of view at each of several successive iterations,
estimating, by the successive iterations, of the vector p from an initial vector p=pᵢₙᵢ and of at least one of a vector c of parameters from an initial vector c=cᵢₙᵢ and of a vector α of parameters from an initial vector α=αᵢₙᵢ, where the vector c of the parameters accounts for the beam hardening of the radiation in the part and the vector α of the parameters characterizes the Compton scattering of the radiation in the part, by minimizing the sum of the norms of the squared differences between the N projections having been acquired and the N computed images,
processing of the N projections and/or of the N computed images comprising a first processing and/or a second processing,
the first processing comprising a correction of the beam hardening over the N projections from the vector c having been estimated or a generation of the beam hardening over the N computed images from the vector c having been estimated,
the second processing comprising a correction of the Compton scattering over the N projections from the vector α having been estimated or a generation of the Compton scattering over the N computed images from the vector α having been estimated,
identifying of defects of the part by comparison of the N projections having been processed with the N computed images having been processed.

16. A device for non-destructive testing of a part by transmission radiography, comprising:
a transmission radiography device, for acquiring of N projections of the part along N different and predetermined angles of view of the part, where N is a given natural integer, a calculator configured to carry out the following steps:
generating of N computed images of the part from a reference model of the part corresponding to the N angles of view and from a vector p of parameters characterizing the projection geometry of the acquisition for the N angles of view at each of several successive iterations,
estimating, by the successive iterations, of the vector p from an initial vector p=pᵢₙᵢ and of at least one of a vector c of parameters from an initial vector c=cᵢₙᵢ and of a vector α of parameters from an initial vector α=αᵢₙᵢ, where the vector c of the parameters accounts for the beam hardening of the radiation in the part and the vector α of the parameters characterizes the Compton scattering of the radiation in the part, by minimizing the sum of the norms of the squared differences between the N acquired projections and the N computed images,
processing of the N projections and/or of the N computed images comprising a first processing and/or a second processing,
the first processing comprising a correction of the beam hardening over the N projections from the vector c having been estimated or a generation of the beam hardening over the N computed images from the vector c having been estimated,
the second processing comprising a correction of the Compton scattering over the N projections from the vector α having been estimated or a generation of the Compton scattering over the N computed images from the vector α having been estimated,
identifying of defects of the part by comparison of the N projections having been processed with the N computed images having been processed.
